(19) United States
(12) Patent Application Publication
(10) Pub. No.: US 2024/0023581 A1
(43) Pub. Date: Jan. 25, 2024

(54) FLAVOUR COMPOSITIONS FOR IMPROVING TASTE IMPRESSIONS

(71) Applicant: SYMRISE AG, Holzminden (DE)

(72) Inventors: Gerhard KRAMMER, Holzminden (DE); Jens KOCH, Eschershausen (DE)

(21) Appl. No.: 18/042,026

(22) PCT Filed: Aug. 18, 2020
(86) PCT No.: PCT/EP2020/073103

§ 371 Date: Feb. 17, 2023

(51) Int. Cl. A23L 27/22; A23L 27/00; A23L 27/26

(52) U.S. Cl. CPC A23L 27/22; A23L 27/88; A23L 27/26

(57) ABSTRACT

The present invention relates to a new flavour composition, a preparation or semi-finished preparation comprising such a flavour composition, and the use of such flavour composition for enhancing and/or imparting desired taste impressions.

The present invention relates to a new flavour composition, a preparation or semi-finished preparation comprising such a flavour composition, and the use of such flavour composition for enhancing and/or imparting desired taste impressions.

Further aspects of the present invention or in connection therewith as well as preferred embodiments will be described below as well as in the attached claims.

Due to different reasons, an increasing number of people rearranges their type of nutrition to a meat-free or meat-reduced nutrition. Several forms and “lifestyles” have developed, ranging from a general reduction of meat in the daily food to a vegetarian or vegan nutrition.

The underlying reasons broadly vary from ethical aspects over religious or cultural conviction up to general well-being and health reasons as well as environmental aspects. As in a majority of cases, the taste of meat and meat products itself is not the cause for reducing/avoiding meat and is frequently still perceived as a pleasant taste, many people are searching for alternative food products which are meat-free but still provide a meat or meat-like taste.

For some time, the food industry has started to develop and provide meat-free food products for replacing meat in the daily nutrition. Usually, these alternatives are protein-based products, which contain flavour compositions to provide a meat-like taste.

As the original taste of meat is a very complex taste including flavours such as “mouthfeel”, “juicy”, “fatty”, or “brothy”, it is very difficult to closely imitate the original taste of meat. Even though several products are already available on the market, which provide an acceptable meat-like taste, and even though the development of improved flavours is ongoing, the difference between meat-containing and meat-free food products can still be perceived by consumers. Even though a high interest and efforts exist in optimizing the meat-like taste, such protein-based products still provide several undesired/unpleasant taste impressions such as a pea off-note or a bitter, earthy, beany and/or chalky taste, in some cases evoked by soybean or some of its proteins, and thus reduce the pleasure of meat-free or meat-reduced nutrition.

Therefore, a high need exists for improving the possibilities of imitating the complex taste of meat to enable a meat-free or meat-reduced nutrition without renouncing the original taste of meat.

It was thus the primary object of the present invention to improve the gustatory quality of food products or flavours compositions, which shall provide a meat-like taste. It was thus an object of the present invention to provide novel preparations, which enhance and/or impart a meat-like taste. Furthermore, it was an object of the present invention to provide novel preparations, which reduce the undesired/unpleasant taste impressions such as a pea off-note and/or a bitter, earthy, beany and/or chalky taste, which are currently perceived in known, in particular soy protein-based, food products or flavours compositions, which shall provide a meat-like taste. Further objects underlying the present invention become apparent when studying the following description including examples and the advantageous effects mentioned herein.

The primary object of the present invention is achieved by a flavour composition comprising
a) an amino acid component comprising three or more amino acids selected from the group consisting of ornithine, proline, aspartic acid, threonine, alanine, serine, histidine, arginine, glutamic acid, glycine, valine, and lysine; and
b) an edible acid component comprising at least one edible acid selected from the group consisting of citric acid, and lactic acid;
   wherein the weight ratio of the amino acid component to the edible acid component ranges from 0.02 to 10, preferably 0.04 to 5.

It is further preferred that the weight ratio of the amino acid component to the edible acid component ranges from 0.1 to 1.5, preferably 0.2 to 0.75.

It was surprisingly found that the flavour composition according to the invention is able to strongly improve the pleasant flavours “juicy”, “fatty”, “mouthfeel”, “brothy”, and “onion” in protein-based food products (cf. nugget A vs. nugget B of Example 2).

When referring herein to amino acid(s), these preferably denote the L-form of the respective amino acid(s), i.e. L-ornithine and/or L-proline and/or L-aspartic acid and/or L-threonine, etc. Moreover, it is to be understood that the amino acids present in the amino acid component may, but must not necessarily, be present in the form of individual amino acids. It is rather assumed that the effects of the invention could also be achieved, if some or all of the specified amino acids were present as peptides, preferably short peptides, in particular di- or tri-peptides. Thus, one, some or all of the amino acids may be provided in the form of peptides, preferably, di- and/or tri-peptides. This means, the amino acid component may be composed of amino acids, peptide(s), preferably di- or tri-peptide(s), or a mixture of amino acid(s) and peptide(s), wherein the amino acids, peptide(s), or mixture of amino acid(s) and peptide(s) comprise three or more amino acids selected from the group consisting of ornithine, proline, aspartic acid, threonine, alanine, serine, histidine, arginine, glutamic acid, glycine, valine, and lysine.

Preferably, the amino acid component comprises four or more, preferably five or more, more preferably six or more, yet more preferably seven or more, yet more preferably eight or more, yet more preferably nine or more, yet more preferably ten or more, yet more preferably eleven or more, most preferably all twelve amino acids selected from the group consisting of ornithine, proline, aspartic acid, threonine, alanine, serine, histidine, arginine, glutamic acid, glycine, valine, and lysine.

The weight ratio define the weight of the amino acid component relative to the weight of the edible acid component. It is to be understood that all amino acids selected from the group consisting of ornithine, proline, aspartic acid, threonine, alanine, serine, histidine, arginine, glutamic acid, glycine, valine, and lysine (if present) count to the weight of the amino acid component. In other terms, the total weight of ornithine, proline, aspartic acid, threonine, alanine, serine, histidine, arginine, glutamic acid, glycine, valine, and lysine (if present) add to the weight of the amino acid component. In some embodiments, amino acids that do not belong to the above group add also to the weight of the amino acid component. In other embodiments, only amino acids that belong to the above group add to the weight of the amino acid component.

Similar remarks apply to the edible acid component. Accordingly, it is to be understood that citric acid and lactic acid (if present) count to the weight of the edible acid component. In some embodiments, edible acids that do not belong to the group of citric acid and lactic acid add also to the weight of the edible acid component. In other embodiments, only edible acids that belong to said group add to the weight of the edible acid component.

In a preferred embodiment of the present invention, the flavour composition according to the invention further comprises
c) a first volatile substance component comprising at least one (e.g., two or more, preferably three or more, more preferably four or more, yet more preferably five or more, yet more preferably seven or more, yet more preferably ten or more, yet more preferably 15 or more, yet more preferably 20 or more) volatile substance selected from the group consisting of caprylic acid, aldehyde c-9, aldehyde c-18, palmitic acid, trans-2-nonenal, stearic acid, aldehyde c-10, aldehyde c-6, 2-methylbutanal, cis-3-hexenol, trans-2-heptenal, trans,trans-2,4-decadienal, trans-2-decenal, capric acid, isovaleraldehyde, lauric acid, myristic acid, pelargonic acid, aldehyde c-5, ethyl palmitate, indole, 2-pentylfuran, benzothiazole, vinylguaiacol, trans,trans-2,4-nonadienal, isovaleric acid, vanillin, acetophenone, trans,trans-2,4-heptadienal, aldehyde c-7, aldehyde c-8, benzaldehyde, heptanoic acid, 6-methyl-5-hepten-2-one, and trans-2,2-phenylbutenal. Optionally, the first volatile substance component further comprises one, two, three, or all of 3,4-dimethyl thiophene, trans methyl-1-propenyl disulphide, benzothiazole, 2,5-dimethyl thiophene, and dimethyl trisulphide.

It was surprisingly found that the addition of component c), as described above, even further improves the pleasant flavour notes “juicy”, “fatty”, and “mouthfeel” in protein-based food products (cf. nugget B vs. nugget C of Example 2). Moreover, the flavour composition of this embodiment is able to strongly reduce the undesired pea off-note in protein-based food products. Accordingly, acceptance of a soy protein based product can thereby be greatly increased (cf. nugget C of Example 2).

Preferably, the first volatile substance component comprises two or more, preferably three or more, more preferably four or more, yet more preferably five or more, yet more preferably seven or more, yet more preferably ten or more, yet more preferably 15 or more, yet more preferably 20 or more, yet more preferably 25 or more, yet more preferably 30 or more, most preferably all volatile substances selected from the group consisting of caprylic acid, aldehyde c-9, aldehyde c-18, palmitic acid, trans-2-nonenal, stearic acid, aldehyde c-10, aldehyde c-6, 2-methylbutanal, cis-3-hexenol, trans-2-heptenal, trans,trans-2,4-decadienal, trans-2-decenal, capric acid, isovaleraldehyde, lauric acid, myristic acid, pelargonic acid, aldehyde c-5, ethyl palmitate, indole, 2-pentylfuran, benzothiazole, vinylguaiacol, trans,trans-2,4-nonadienal, isovaleric acid, vanillin, acetophenone, trans,trans-2,4-heptadienal, aldehyde c-7, aldehyde c-8, benzaldehyde, heptanoic acid, 6-methyl-5-hepten-2-one, and trans-2,2-phenylbutenal. Optionally, the first volative substance component further comprises one, two, three, or all of 3,4-dimethyl thiophene, trans methyl-1-propenyl disulphide, benzothiazole, 2,5-dimethyl thiophene, and dimethyl trisulphide.

It is even further preferred that the weight ratio of the amino acid component to the first volatile substance component ranges from 0.3 to 5.2, preferably 0.6 to 2.6.

To calculate the above weight ratio, all volatile substances selected from the group consisting of caprylic acid, aldehyde c-9, aldehyde c-18, palmitic acid, trans-2-nonenal, stearic acid, aldehyde c-10, aldehyde c-6, 2-methylbutanal, cis-3-hexenol, trans-2-heptenal, trans,trans-2,4-decadienal, trans-2-decenal, capric acid, isovaleraldehyde, lauric acid, myristic acid, pelargonic acid, aldehyde c-5, ethyl palmitate, indole, 2-pentylfuran, benzothiazole, vinylguaiacol, trans,trans-2,4-nonadienal, isovaleric acid, vanillin, acetophenone, trans,trans-2,4-heptadienal, aldehyde c-7, aldehyde c-8, benzaldehyde, heptanoic acid, 6-methyl-5-hepten-2-one, and trans-2,2-phenylbutenal (if present) count to the weight of the first volatile substance component. Volatile substances that do not belong to said group do not add to the weight of the first volatile substance component.

In a further preferred embodiment of the present invention, the flavour composition comprises
d) a second volatile substance component comprising at least one volatile substance selected from the group consisting of 1,3-octenol, trans-2-octenal, trans-2-octenol, alcohol c-8, palm free vegetable oil triglyceride, and 1,3-octenon/ol.

It has been surprisingly found that the second volatile substance component strongly emphasizes the flavour note “mushroom” (cf. nugget C vs. nugget D of Example 2).

Preferably, 1,3-octenon/ol, if present, is in a 65:35 configuration.

It is further preferred that the weight ratio of the amino acid component to the second volatile substance component ranges from 0.6 to 10.4, preferably 1.3 to 5.2.

It is to be understood that for the calculation of the weight ratio, the weight of all of 1,3-octenol, trans-2-octenal, trans-2-octenol, alcohol c-8, palm free vegetable oil triglyceride, and 1,3-octenon/ol (if present) count to the weight of the second volatile substance component. Other volatile substances do not add to the weight of the second volatile substance component.

As far as not already included in any of the components a), b), c) or d), it is further preferred that the flavour composition according to the invention further comprises
e) at least one substance selected from sugars, ribonucleotides, nucleosides, mineral substances.

Preferably, the flavour composition according to the invention further comprises two or more, preferably three or more, most preferably four or more substances selected from the group of sugars, ribonucleotides, nucleosides, and mineral substances.

In case a substance belonging to component e) can be considered to belong also to one of the components a), b), c) or d), the substance shall be defined to belong to the respective component a), b) c) or d) (and not to component e)) for all calculations of weights and weight ratios.

According to a preferred embodiment of the present invention, the amino acid component (as defined herein) comprises ornithine, alanine, arginine, and glutamic acid.

Preferably, the flavor composition comprises ornithine and alanine in a weight ratio of ornithine to alanine ranging from 0.04 to 3.89, preferably 0.08 to 1.94, more preferably 0.16 to 0.97.

Preferably, the flavor composition comprises ornithine and arginine in a weight ratio of ornithine to arginine ranging from 0.39 to 3.89, preferably 0.08 to 1.94, more preferably 0.16 to 0.97.

Preferably, the flavor composition comprises ornithine and glutamic acid in a weight ratio of ornithine to glutamic acid ranging from 0.10 to 10.44, preferably 0.21 to 5.22, more preferably 0.42 to 2.61.

Preferably, the flavor composition comprises alanine and arginine in a weight ratio of alanine to arginine ranging from 0.10 to 10.00, preferably 0.20 to 5.00, more preferably 0.40 to 2.50.

Preferably, the flavor composition comprises alanine and glutamic acid in a weight ratio of alanine to glutamic acid ranging from 0.27 to 26.98, preferably 0.54 to 13.49, more preferably 1.08 to 6.75.

Preferably, the flavor composition comprises arginine and glutamic acid in a weight ratio of arginine to glutamic acid ranging from 0.27 to 26.98, preferably 0.54 to 13.49, more preferably 1.08 to 6.75.

The edible acid component preferably comprises citric acid and lactic acid. It is further preferred that the weight ratio of citric acid to lactic acid ranges from 0.022 to 2.2, preferably 0.044 to 1.1, more preferably 0.088 to 0.55.

According to a preferred embodiment of the present invention, the first volatile substance component comprises caprylic acid, aldehyde c-9, aldehyde c-18, palmitic acid, trans-2-nonenal, aldehyde c-10, aldehyde c-6, 2-methylbutanal, cis-3-hexenol, trans-2-heptenal, trans,trans-2,4-decadienal, trans-2-decenal, isovaleraldehyde, 2-pentylfuran, benzothiazole, vinylguaiacol, trans,trans-2,4-nonadienal, vanillin, acetophenone, aldehyde c-7, aldehyde c-8, benzaldehyde, and 6-methyl-5-hepten-2-one.

Preferably, the flavour composition comprises the aforementioned substances of the first volatile substance component in a weight ratio that ranges from 0.1 times to 10 times, preferably 0.2 times to 5 times, more preferably 0.4 times to 2.5 times, of the weight ratio used in the example section.

Preferably, the first volatile substance component comprises caprylic acid, aldehyde c-9, aldehyde c-18, palmitic acid, trans-2-nonenal, aldehyde c-10, aldehyde c-6, 2-methylbutanal, cis-3-hexenol, trans-2-heptenal, trans,trans-2,4-decadienal, trans-2-decenal, isovaleraldehyde, lauric acid, indole, 2-pentylfuran, benzothiazole, vinylguaiacol, trans,trans-2,4-nonadienal, isovaleric acid, vanillin, acetophenone, trans,trans-2,4-heptadienal, aldehyde c-7, aldehyde c-8, benzaldehyde, and 6-methyl-5-hepten-2-one.

Preferably, the flavour composition comprises the aforementioned substances of the first volatile substance component in a weight ratio that ranges from 0.1 times to 10 times, preferably 0.2 times to 5 times, more preferably 0.4 times to 2.5 times, of the weight ratio used in the example section.

The present invention further relates to a preparation for nourishment or pleasure, comprising a flavour composition as discloses herein. Preferably, the total amount of the flavour composition is sufficient to impart and/or enhance a desired taste impression, preferably of the type(s) juicy, fatty, brothy, and/or mouthfeel. For this purpose, it is further preferred that the preparation includes the flavour composition in an amount of at least 0.05 wt.-%, preferably at least 0.1 wt.-%, relative to the total weight of the preparation. Preferably, the preparation includes the flavour composition in an amount of 2 wt.-% or less, preferably 1 wt.-% or less, relative to the total weight of the preparation.

In a preferred embodiment, the preparation is a protein-based preparation and/or a protein-enriched preparation. Preferably, the preparation comprises at least 30 wt.-%, preferably at least 40 wt.-%, preferably at least 50 wt.-%, preferably at least 60 wt.-%, preferably at least 70 wt.-%, preferably at least 80 wt.-%, preferably at least 90 wt.-% proteins, based on the total weight of the preparation.

Preferably, the protein-based preparation and/or the protein-enriched preparation as described herein is selected from the group consisting of vegan or vegetarian products that imitate meat products (meat substitute) such as fresh meat like steak, chicken breast, cutlet, etc.; minced meat like mince meat from beef, pork, poultry; structured mince meat like burger patties, chevapcici, chicken nuggets etc.; coated meat products like nuggets, wiener cutlet, cordon blue etc.; meat pieces/stripes, like beef or chicken stripes, kebab; sausages cooked like hot dogs and raw like course sausages; fermented meat like salami; pates like liverpate, teewurst etc.; cooked and raw ham; bacon; as well as the respective meat products themselves. Preferably, the protein-based preparation and/or the protein-enriched preparation is a soy protein-based or soy protein-enriched product. If the protein-based preparation and/or the protein-enriched preparation is a soy protein-based or soy protein-enriched product, the effects obtained by the present invention can be mostly utilized because the acceptance of such products can be greatly improved by the flavour composition of the present invention.

It has been found that the effects of the present invention, i.e. imparting and/or enhancing the pleasant taste impressions as described herein, can be best exploited in products that imitate meat products as described herein. Notwithstanding, the present invention is not confined to such products. The skilled person will rather appreciate that the taste impression can be also utilized in non-vegan or non-vegetarian meat products.

The present invention further relates to a semi-finished product for the production of a preparation for nourishment or pleasure, the semi-finished product comprising a flavour composition as defined herein. The semi-finished product as described herein is preferably selected from the group consisting of semi-finished product seasonings i.e. type cevapcici, type kebab, type minced, type pulled, type burger, type chicken nugget; vegan products that imitate eggs (liquid, cooked, scrambled), cheese (hard cheese, soft cheese, fresh cheese), dairy products like milk and yoghurt, ice-cream or fish (raw, cooked); products that are made from plant protein like falafel or humus; meat products like mechanically separated meat mechanically recovered/reclaimed meat or mechanically deboned meat.

In case of a semi-finished product, it is preferred that the amount of the flavour composition in the semi-finished product ranges from 1 to 70 wt.-%, preferably 5 to 50 wt.-%, more preferably 10 to 40 wt.-%.

The present invention further relates to the use of a flavour composition as defined herein to impart and/or enhance a desired taste impression, preferably of the type(s) juicy, fatty, brothy, and/or mouthfeel, in a preparation for nourishment or pleasure, or in a semi-finished product for the production of a preparation for nourishment or pleasure. Preferably, the preparation is a preparation as defined herein. It is further preferred that the total amount of the flavour composition is sufficient to impart and/or enhance a desired taste impression, preferably of the type(s) juicy, fatty, brothy, and/or mouthfeel.

The present invention further relates to the use of a flavour composition as defined herein to reduce and/or mask an undesired sensory taste impression, preferably bitter, earthy, beany and/or chalky and/or a pea off-note, in a preparation for nourishment or pleasure, or in a semi-finished product for the production of a preparation for nourishment or pleasure. Preferably, the preparation is a preparation as defined herein and in particular a soy protein-based or soy protein-enriched preparation.

The term “pea off-note” is well known to a skilled person and frequently used in the field of flavourings. Preferably, it may also be described as “earthy”, “beany” or “chalky”. The same taste impressions (“earthy”, “beany” or “chalky”) are also frequently evoked by soybean products or by one or more proteins of soybeans.

The present invention, preferred embodiments thereof and several aspects in connection therewith will be described further below in the form of selected examples.

In the drawings:

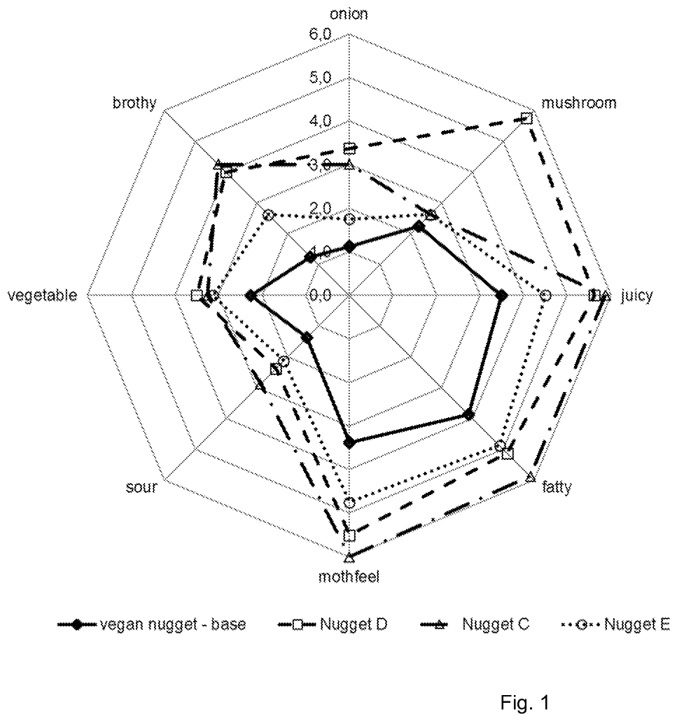

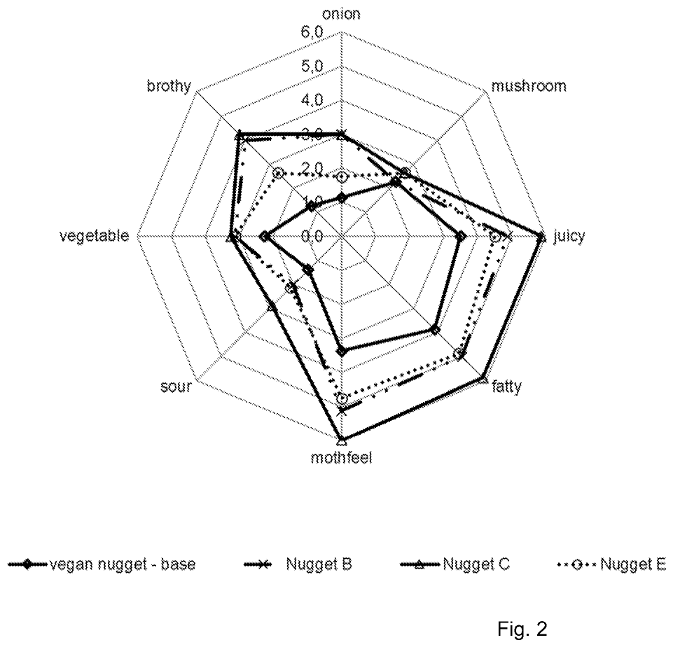

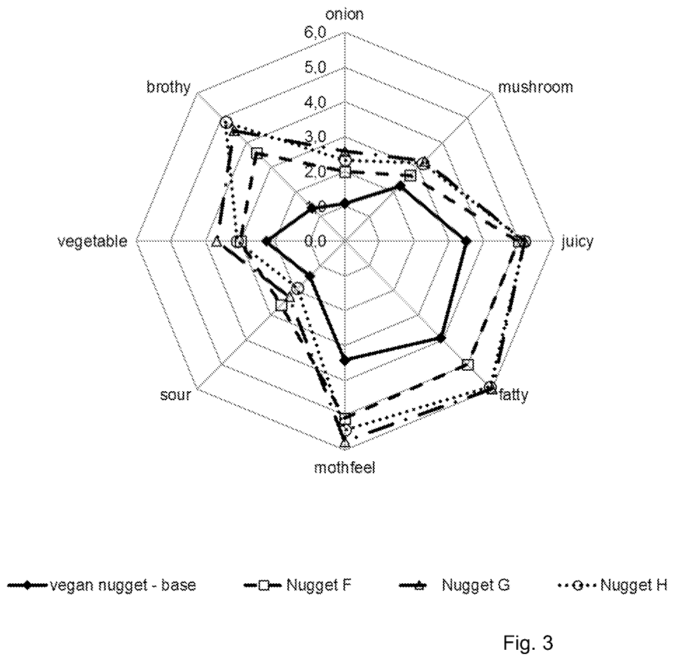

FIGS. 1 to 3 show the evaluation of the sensory profile of vegan nuggets provided with different flavour compositions.

### EXAMPLES

### Example 1: Test System—Vegan Nugget Base and Flavour Components

### Base: Vegan Nugget Base

As a test system for the flavour composition according to the invention, a vegan nugget base included the following ingredients:

| Ingredients | Amount [wt.-%] |
|---|---|
| Water | 59 |
| Sanacel bamboo 200 (fibre) | 0.7 |
| Soy protein textured response 4310 IP | 13 |
| Soy protein isolate supro 670 IP | 5 |
| Methyl cellulose metolose MCE-100TS | 1.8 |
| Dextrose anhydrous ex corn IP | 1.7 |
| Salt | 1.2 |
| Sanacel bamboo add fb (fibre) | 0.7 |
| Carrageenan frimulsion WG-181 | 0.3 |
| Yeast extract Gistex XII Aggl. | 0.25 |
| Lactic acid 60% Nat. powder | 0.17 |
| Food color titanium dioxide powder E171 | 0.1 |
| Ginger ground | 0.04 |
| Succinic acid | 0.02 |
| Citric acid anhydrous fine | 0.02 |
| Vegetable oil (sunflower) | 12 |
| Coconut oil | 4 |
| Sum | 100 |

Instead of the above vegan nugget base, any other edible base can be used in combination with the flavour composition of the invention.

The flavour components assessed were the following:

### Component A) Amino Acid Component

| Ingredients | Amount [g] |
|---|---|
| L-ornithine HCl | 10.779 |
| L-proline | 3.160 |
| L- aspartic acid | 6.079 |
| L- threonine | 1.740 |
| L-alanine | 27.846 |
| L-serine | 2.920 |
| L-histidine | 3.030 |
| L-arginine | 27.847 |
| glutamic acid | 10.329 |
| glycine | 4.490 |
| L-valine | 0.560 |
| L-lysine HCl | 1.220 |
| Sum | 100 |

### Component B) Edible Acid Component

| Ingredients | Amount [g] |
|---|---|
| citric acid (monohydrate) | 4.760 |
| lactic acid (Evospray ® 22% gelatine free) | 95.240 |
| Sum | 100 |

### Component C) First Volatile Substance Component (“Fatty”)

| Ingredients | Amount [g] |
|---|---|
| caprylic acid | 0.300 |
| aldehyde c-9 | 0.100 |
| aldehyde c-18 SOG. | 0.060 |
| palmitic acid | 8.000 |
| trans-2-nonenal | 0.050 |
| stearic acid | 0.600 |
| aldehyde c-10 | 0.060 |
| aldehyde c-6 | 0.600 |
| 2-methylbutanal | 0.060 |
| cis-3-hexenol | 0.040 |
| trans-2-heptenal | 0.600 |
| trans,trans-2,4-decadienal | 0.040 |
| trans-2-decenal | 0.160 |
| capric acid | 0.400 |
| isovaleraldehyde | 0.240 |
| lauric acid | 1.600 |
| myristic acid | 4.000 |
| pelargonic acid | 0.070 |
| aldehyde c-5 | 0.040 |
| ethyl palmitate | 0.040 |
| Indole FF 1% VTPF | 1.000 |
| 2-pentylfuran 1% VTPF | 1.200 |
| Benzothiazole 1% TRIA | 1.200 |
| Vinylguaiacol 10% TRIC | 0.480 |
| trans,trans-2,4-nonadienal 1% TRIC | 2.000 |
| isovaleric acid 1% TRIC | 1.000 |
| Vanillin 10% TRIC | 0.400 |
| Acetophenone FG 10% TRIC | 0.200 |
| trans,trans-2,4-heptadienal 1% TRIC | 1.000 |
| aldehyde c-7 1% TRIC | 3.000 |
| aldehyde c-8 FG | 0.080 |
| Benzaldehyde DD | 0.040 |
| heptanoic acid | 0.040 |
| 6-methyl-5-hepten-2-one | 0.040 |
| trans-2,2-phenylbutenal 1% TRIC | 2.000 |
| Fill up with vegetable oil triglyceride palm free to: | 1000.000 |

Abbreviations used:
DD = double distilled,
VTPF = vegetable oil triglycerides palmfree,
FG = Foodgrade,
Tria = Triacetin,
Tric = Triacetin Palmfree,
FF = dient

### Component D) Second Volatile Substance Component (“Mushroom”)

| Ingredients | Amount [g] |
|---|---|
| 1,3-octenol | 0.800 |
| trans-2-octenal | 0.800 |
| trans-2-octenol | 0.400 |
| alcohol c-8 | 0.400 |
| vegetable oil triglyceride palm free | 996.300 |
| 1,3-octenon/ol 65:35 | 1.300 |
| Sum | 1000.000 |

Component E) Amino acid Component (“Short List”)

| Ingredients | Amount [g] |
|---|---|
| L-ornithine HCl | 14.031 |
| L-alanine | 36.264 |
| L-arginine | 36.264 |
| glutamic acid | 13.441 |
| Sum | 100 |

### Component F) First Volatile Substance Component (“First Short List”)

| Ingredients | Amount [g] |
|---|---|
| caprylic acid | 0.034 |
| aldehyde c-9 | 0.010 |
| aldehyde c-18 SOG. | 0.006 |
| palmitic acid | 1.000 |
| trans-2-nonenal | 0.005 |
| aldehyde c-10 | 0.006 |
| aldehyde c-6 | 0.062 |
| 2-methylbutanal | 0.006 |
| cis-3-hexenol | 0.004 |
| trans-2-heptenal | 0.060 |
| trans,trans-2,4-decadienal | 0.004 |
| trans-2-decenal | 0.016 |
| isovaleraldehyde | 0.024 |
| lauric acid | 0.160 |
| Indole FF 1% VTPF | 0.100 |
| 2-pentylfuran 1% VTPF | 0.120 |
| Benzothiazole 1% TRIA | 0.120 |
| Vinylguaiacol 10% TRIC | 0.048 |
| trans,trans-2,4-nonadienal 1% TRIC | 0.200 |
| isovaleric acid 1% TRIC | 0.100 |
| Vanillin 10% TRIC | 0.040 |
| Acetophenone FG 10% TRIC | 0.020 |
| trans,trans-2,4-heptadienal 1% TRIC | 0.100 |
| aldehyde c-7 1% TRIC | 0.300 |
| aldehyde c-8 FG | 0.008 |
| Benzaldehyde DD | 0.004 |
| 6-methyl-5-hepten-2-one | 0.004 |
| Fill up with vegetable oil triglyceride palm free to: | 100.000 |

### Component G) First Volatile Substance Component (“Second Short List”)

| Ingredients | Amount [g] |
|---|---|
| caprylic acid | 0.034 |
| aldehyde c-9 | 0.010 |
| aldehyde c-18 SOG. | 0.006 |
| palmitic acid | 1.000 |
| trans-2-nonenal | 0.005 |
| aldehyde c-10 | 0.006 |
| aldehyde c-6 | 0.062 |
| 2-methylbutanal | 0.006 |
| cis-3-hexenol | 0.004 |
| trans-2-heptenal | 0.060 |
| trans,trans-2,4-decadienal | 0.004 |
| trans-2-decenal | 0.016 |
| isovaleraldehyde | 0.024 |
| 2-pentylfuran 1% VTPF | 0.120 |
| Benzothiazole 1% TRIA | 0.120 |
| Vinylguaiacol 10% TRIC | 0.048 |
| trans,trans-2,4-nonadienal 1% TRIC | 0.200 |
| Vanillin 10% TRIC | 0.040 |
| Acetophenone FG 10% TRIC | 0.020 |
| aldehyde c-7 1% TRIC | 0.300 |
| aldehyde c-8 FG | 0.008 |
| Benzaldehyde DD | 0.004 |
| 6-methyl-5-hepten-2-one | 0.004 |
| Fill up with vegetable oil triglyceride palm free to: | 100.000 |

### Example 2: Sensory Profiles

The ingredients of the vegan nugget base (Base) and of one or more flavour components a), b), c), d), e), f) and g) of Example 1 were mixed. The mixture was conventionally processed to nuggets A to D and F to H, respectively including the following components:
A: Vegan nugget base
B: Vegan nugget base
   +flavour component a) (0.04 wt.-% of the final nugget)
   +flavour component b) (0.105 wt.-% of the final nugget)
C: Vegan nugget base
   +flavour component a) (0.04 wt.-% of the final nugget)
   +flavour component b) (0.105 wt.-% of the final nugget)
   +flavour component c) (0.03 wt.-% of the final nugget)
D: Vegan nugget base
   +flavour component a) (0.04 wt.-% of the final nugget)
   +flavour component b) (0.105 wt.-% of the final nugget)
   +flavour component c) (0.03 wt.-% of the final nugget)
   +flavour component d) (0.015 wt.-% of the final nugget)
E: Vegan nugget base
   +proprietary flavour composition as internal reference (0.2 wt.-% of the final nugget)
F: Vegan nugget base
   +flavour component e) (0.05 wt.-% of the final nugget)
G: Vegan nugget base
   +flavour component e) (0.05 wt.-% of the final nugget)
   +flavour component f) (0.03 wt.-% of the final nugget)
H: Vegan nugget base
   +flavour component e) (0.05 wt.-% of the final nugget)
   +flavour component g) (0.03 wt.-% of the final nugget)

The sensory profile of the nuggets A to H was evaluated with a sample size of n =4 to 12 for each nugget and using a score between 1 and 6, whereby 1 indicates poorest flavour and 6 indicates the richest flavour. The following table indicates the respective mean value. The results are also illustrated in FIGS. 1 to 3, wherein nugget A is denoted as “vegan nugget-base”.

| | onion | mushroom | juicy | fatty | mouthfeel | sour | vegetable | brothy |
|---|---|---|---|---|---|---|---|---|
| Nugget A | 1.1 | 2.3 | 3.5 | 3.9 | 3.4 | 1.4 | 2.3 | 1.3 |
| Nugget B | 3.0 | 2.3 | 4.9 | 5.0 | 5.1 | 2.0 | 3.1 | 4.0 |
| Nugget C | 3.0 | 2.6 | 5.9 | 5.9 | 6.0 | 2.9 | 3.3 | 4.3 |
| Nugget D | 3.4 | 5.8 | 5.6 | 5.1 | 5.5 | 2.4 | 3.5 | 4.0 |
| Nugget E | 1.8 | 2.6 | 4.5 | 4.9 | 4.8 | 2.1 | 3.1 | 2.6 |
| Nugget F | 2.0 | 2.7 | 5.0 | 5.0 | 5.1 | 2.6 | 3.0 | 3.6 |
| Nugget G | 2.6 | 3.3 | 5.2 | 6.0 | 5.8 | 2.3 | 3.7 | 4.5 |
| Nugget H | 2.3 | 3.2 | 5.2 | 5.9 | 5.4 | 1.9 | 3.1 | 4.8 |

According to the sensory data, the combination of the amino acid component 1 and the edible acid component 2 led to a significant improvement in the profile attributes juicy (meat juiciness), fatty, brothy, onion and mouthfeel (mouth coating and mouth watering/umami) (cf. results for Nugget B). Adding to this combination the first volatile substance component resulted in an even further optimized sensory profile (cf. results for Nugget C), which was able to significantly increase the acceptance of a soy protein based vegan nugget.

When the second volatile substance component was additionally added, the flavour profile was shifted towards a mushroom note (cf. results for Nugget D).

Notably, with the flavour compositions included in Nuggets B, C and D the flavour profile attributes juicy (meat juiciness), fatty, brothy, onion and mouthfeel (mouth coating and mouth watering/umami) could be improved, which improvement was even more pronounced than that achieved with a proprietary flavour composition, which was used as an internal standard.

When reducing the number of compounds used as the amino acid component (Nugget F), a significant improvement in the flavour attributes juicy, fatty, brothy, onion and mouthfeel was likewise obtained. Adding to this combination a first volatile substance component, which as compared to Nuggets C contained a reduced number of compounds (Nuggets G and H), all tested flavour attributes except sour could be additionally improved. These results demonstrate that it is possible to achieve a desired flavour profile with a reduced number of substances in the amino acid component and/or the first volatile substance component.

1-15. (canceled)

16. A flavor composition comprising:
(a) an amino acid component comprising three or more amino acids selected from ornithine, proline, aspartic acid, threonine, alanine, serine, histidine, arginine, glutamic acid, glycine, valine, and lysine;
(b) an edible acid component comprising one or more edible acids selected from citric acid and lactic acid;
wherein the amino acid component (a) and the edible acid component (b) are in a weight ratio of 0.02 to 10 ((a)/(b)).

17. The flavour composition of claim 16, wherein the composition further comprises:
(c) a first volatile substance component comprising one or more volatile substances selected from caprylic acid, aldehyde c-9, aldehyde c-18, palmitic acid, trans-2-nonenal, stearic acid, aldehyde c-10, aldehyde c-6, 2-methylbutanal, cis-3-hexenol, trans-2-heptenal, trans,trans-2,4-decadienal, trans-2-decenal, capric acid, isovaleraldehyde, lauric acid, myristic acid, pelargonic acid, aldehyde c-5, ethyl palmitate, indole, 2-pentylfuran, benzothiazole, vinylguaiacol, trans,trans-2,4-nonadienal, isovaleric acid, vanillin, acetophenone, trans,trans-2,4-heptadienal, aldehyde c-7, aldehyde c-8, benzaldehyde, heptanoic acid, 6-methyl-5-hepten-2-one, and trans-2,2-phenylbutenal.

18. The flavor composition of claim 16, wherein the amino acid component (a) and the first volatile substance component (b) are in a weighty ratio of 0.3 to 5.2 ((a)/(b)).

19. The flavor composition of claim 16, wherein the composition further comprises:
(d) a second volatile substance component comprising one or more volatile substances selected from 1,3-octenol, trans-2-octenal, trans-2-octenol, alcohol c-8, palm free vegetable oil triglyceride, and 1,3-octenon/ol.

20. The flavor composition of claim 19, wherein the amino acid component (a) and the second volatile substance component (d) are in a weight ratio of 0.6 to 10.4 ((a)/(d)).

21. The flavor composition 16, wherein the composition further comprises:
(e) one or more substances selected from sugars, ribonucleotides, nucleosides, and mineral substances.

22. The flavor composition of claim 16, wherein the amino acid component (a) comprises ornithine, alanine, arginine, and glutamic acid.

23. The flavor composition of claim 17, wherein the first volatile substance (c) comprises caprylic acid, aldehyde c-9, aldehyde c-18, palmitic acid, trans-2-nonenal, aldehyde c-10, aldehyde c-6, 2-methylbutanal, cis-3-hexenol, trans-2-heptenal, trans,trans-2,4-decadienal, trans-2-decenal, isovaleraldehyde, 2-pentylfuran, benzothiazole, vinylguaiacol, trans,trans-2,4-nonadienal, vanillin, acetophenone, aldehyde c-7, aldehyde c-8, benzaldehyde, and 6-methyl-5-hepten-2-one.

24. The flavor composition of claim 17, wherein the first volatile substance (c) comprises caprylic acid, aldehyde c-9, aldehyde c-18, palmitic acid, trans-2-nonenal, aldehyde c-10, aldehyde c-6, 2-methylbutanal, cis-3-hexenol, trans-2-heptenal, trans,trans-2,4-decadienal, trans-2-decenal, isovaleraldehyde, lauric acid, indole, 2-pentylfuran, benzothiazole, vinylguaiacol, trans,trans-2,4-nonadienal, isovaleric acid, vanillin, acetophenone, trans,trans-2,4-heptadienal, aldehyde c-7, aldehyde c-8, benzaldehyde, and 6-methyl-5-hepten-2-one.

25. A preparation for nourishment or pleasure comprising the flavor composition of claim 16.

26. The preparation of claim 25 comprising at least 0.05 wt. % of the flavor composition of claim 1, relative to a total weight of the preparation.

27. The preparation of claim 25, wherein the preparation is a protein-based preparation, a protein-enriched preparation, and/or a meat substitute.

28. A semi-finished product for production of a preparation for nourishment or pleasure, the semi-finished product comprising the flavor composition of claim 16.

29. A method for imparting and/or enhancing a desired taste impression and/or reducing or masking an undesired taste impression comprising adding a flavor composition of claim 16 to preparation for nourishment or pleasure or to a semi-finished product for production of a preparation for nourishment or pleasure.

30. The method of claim 29, wherein the desired taste impression is selected from juicy, fatty, brothy, mouthfeel, or a combination thereof and/or the undesired taste impression is pea off-note.

31. The preparation of claim 25 comprising at least 0.1 wt. % of the flavor composition, relative to a total weight of the preparation.

32. The preparation of claim 25 comprising 2 wt. % or less of the flavor composition, relative to a total weight of the preparation.

33. The preparation of claim 25 comprising 1 wt. % or less of the flavor composition, relative to a total weight of the preparation.
